(19) United States
(12) Patent Application Publication
(10) Pub. No.: US 2007/0151316 A1
(43) Pub. Date: Jul. 5, 2007

(54) Bardachenko cylindrical lock

(76) Inventor: Vitaly Bardachenko, Kiev (UA)

Correspondence Address: COOLEY GODWARD KRONISH LLP;ATTN: PATENT GROUP, Suite 500, 1200 - 19th Street, NW, WASHINGTON, DC, 20036-2402, US

(21) Appl. No.: 10/546,971

(22) PCT Filed: Feb. 25, 2004
(86) PCT No.: PCT/UA04/00012

§ 371 Date: Dec. 11, 2006

(30) Foreign Application Priority Data
Feb. 26, 2003 (UA) 2003021705

(51) Int. Cl. E05B 29/04

(52) U.S. Cl. 70/492

(57) ABSTRACT

The invention relates to locking devices, more specifically to cylindrical locks. The inventive lock comprises a body provided with slots, a rotatable cylinder provided with a key channel and slots which are diametrically embodied in the cross-sections thereof a packet of locking plates which are movably arranged in the cylinder slots in such a way that the locking ends thereof are insertable into the body slots. The inventive structural design makes it possible to reduce the information content of the locking plates of the lock, thereby improving the secrecy and reliability thereof and enabling said lock to re-coded for any coding key combination.

### AREA OF TECHNOLOGY

The invention relates to locking devices, and specifically to locks for doors of various types.

### PRIOR ART

A cylindrical lock is known, Russian patent No. 2058467, that comprises a body, a rotatable cylinder disposed in it provided with a channel for a key and a packet of locking plates with profiled apertures for a key. The disadvantages of this lock include the complexity of its design and production and the unreliability of its operation.

There is also known a cylindrical lock, Russian patent No. 2060336, that comprises a body with slots disposed in the body, a rotatable cylinder provided with a key slot and slots which are diametrically embodied in the cross-sections thereof, a packet of locking plates, movably arranged in the slots of the cylinder in such a way that the locking ends are insertable into the body slot, which ends are spring-loaded between their bearing plates and the bearing lands of the cylinder in one direction of their motion, and having an aperture for a key. This cylindrical lock was selected as the prototype for this invention.

This lock likewise has disadvantages.
1) The lock is closed (the cylinder is locked) by displacement of the apertures of the plates relative to the center of the cylinder and in different directions for the entire set of plates, which leads to mismatches in the steps of the edges of the aperture of the different plates.
2) The one-sided spring-loading of the plates and the associated one-sided resistance to movement of the plates, together with the cited steps is the edges of the apertures significantly increase the unambiguity of the plates of the closed lock, that is, it reduces its secrecy and consequently, its reliability.
3) In accordance with the cited features of the design of the lock and the configuration of the apertures of the plates, every code position provides only one position of the plates—“up” or “down”—thereby reducing the combinatorial possibilities of the packet of plates.
4) The design adopted for the unit for placing the plates in the cylinder, including the resistance of the plates in the lock body, complicates its installation and its recoding.

### DISCLOSURE OF THE INVENTION

The object of the invention is to create an improved cylindrical lock by displacing the longitudinal dimensions of the locking plates relative to the transverse axes of the apertures of the plates by the magnitude of their locking ends; the plates are additionally spring-loaded in the other direction of their motion and are provided with equalizing elements to their maximum movement in both directions, which reduces the information content of the state (position) of the locking plates, that is, it enhances the secrecy of the lock and its reliability. This is provided by the fact that the invention, which has the cited features of the prototype, in contrast to it provides for: the axis of the key channel and the transverse axes of the apertures of these plates passing through the center of the rotatable cylinder; the contact edges of the plate apertures are symmetrical relative the transverse axes of these apertures; the longitudinal dimensions of the locking plates are shifted relative to the transverse axes of these apertures by the magnitude of their locking ends, with the plates likewise being spring-loaded in the other direction of their motion and provided with equalizing elements to their maximum movement in both directions.

The cited shift of the longitudinal dimensions of these plates relative to the transverse axes of their apertures ensures closure of the cylinder without displacement of the plates in different directions relative to the center of the cylinder, which eliminates the stepped edges of the apertures. This is also enhanced by the symmetry of the contact edges of the plate apertures relative the transverse axes of these apertures,

The two directions of motion of the plates and the equality of their maximum movement in both directions eliminates the possibility of determining the directions of the operating motion of the plates. This factor, together with the cited absence of stepped edges of the apertures of the plates, eliminates the possibility of a stranger obtaining information about the motion and position of each locking plate in a closed cylinder, thereby enhancing the secrecy of the lock and its reliability.

At the same time, the orientation of the axis of the key channel and the transverse axes of the plate apertures along the center of the rotatable cylinder ensures a selection of plates with the cited displacement of the longitudinal dimension of code combinations with a differing positions of the plates “up” or “down.” At the same time, the bilateral spring-loading of the plates and the equality of their maximum travel act in conjunction with the cited difference in position of the plates and to each code position [problem with grammar of original text]. This enhances the coding possibilities of the packet of plates in preserving the uniformity of the plates.

To simplify the design of the lock of the invention, the elements providing for equality of maximum travel in both directions of the plates includes plate guide rods for the springs and the cited bearing lands of the cylinder, with the ends of the corresponding rods and bearing lands being pair-wise symmetrical relative to the center of the cylinder.In this way, known design elements are utilized to achieve the object of the invention. At the same time, for convenience of installation of the lock, these bearing lands of the cylinder are made removable, in the form of support brackets.

In addition, each code position has additional spring-loaded bearing lands that are symmetrical relative to the center of the cylinder and have slots to allow the passage of the plates, with the distance between these bearing lands being not less than the distances between the bearing lands of the plates.

This ensures the original correct position of the locking plates in the cylinder by allowing for the possibility of different spring stiffnesses.

### BRIEF DESCRIPTION OF THE DRAWINGS

The essence of the invention is explained by the drawings.

FIG. 1. View of the lock, plan view with cross section.

FIG. 2. Cross section along A-A of FIG. 1.

FIG. 3. Rotatable cylinder in cross section along A-A of FIG. 1.

FIG. 4. Rotatable cylinder in longitudinal section.

FIG. 5. Locking plate.

FIG. 6. Support bracket.

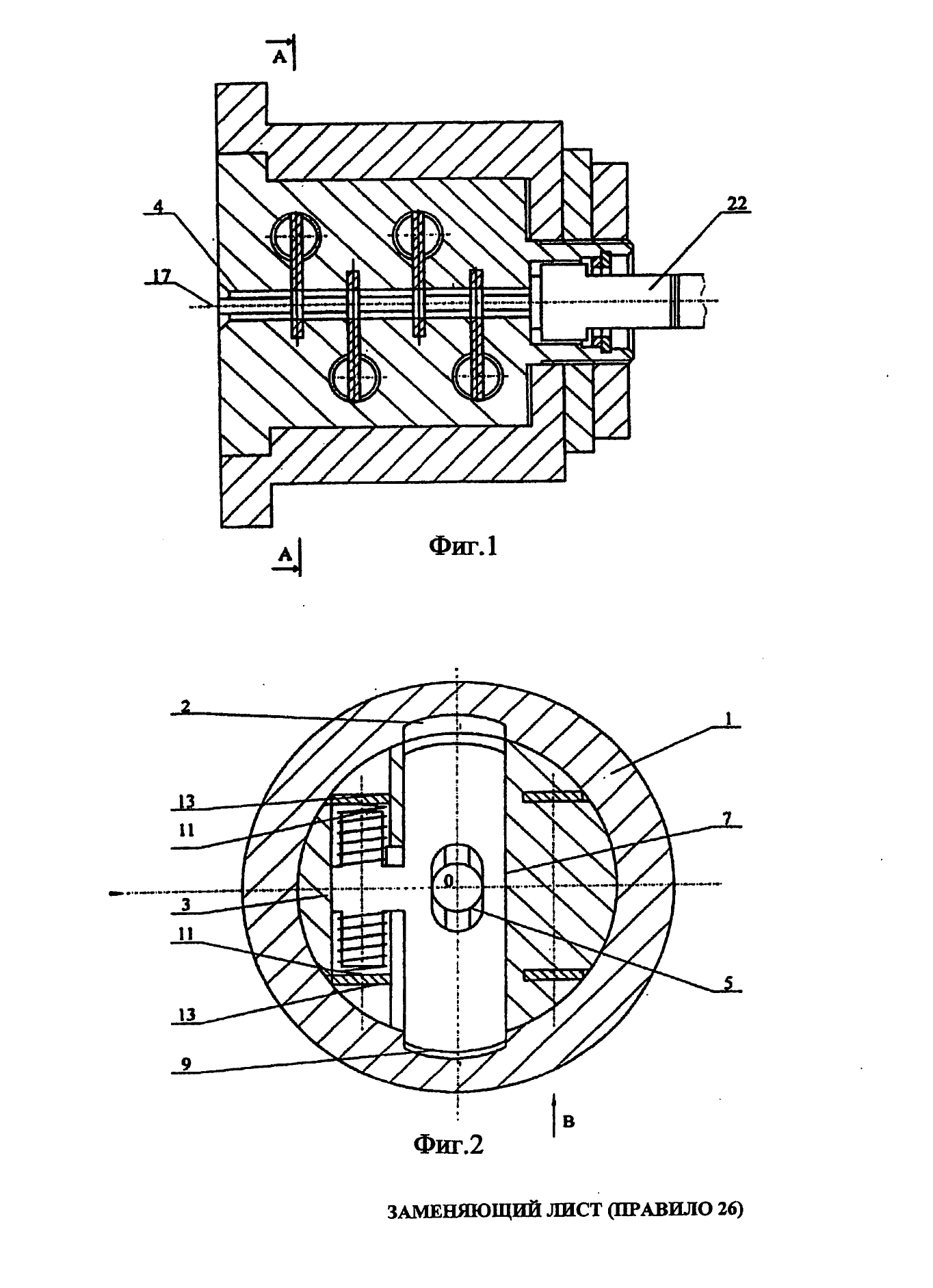

### AN EMBODIMENT OF THE INVENTION

In accordance with the invention the lock comprises a body with slots 2, a rotatable cylinder 3 disposed in the body provided with a slot 4 for a key 5 and recesses 6 in its transverse sections. Locking plates 7 are movably installed in recesses 6, which have apertures 8. To allow insertion of the locking ends 9 of plates 7 and slot 2 of the body 1, the recesses 6 of the cylinder 3 and the slot 2 are oriented identically to the diameter of their components, for example, by being diametrically disposed.

The locking plates have guide rods 10 on which springs 11 are mounted, between the bearing lands 12 of the plates 7 and the bearing lands 13 of the cylinder 3.

For convenience of installation of the lock, the latter bearing lands are embodied in the form of support bracket 14.

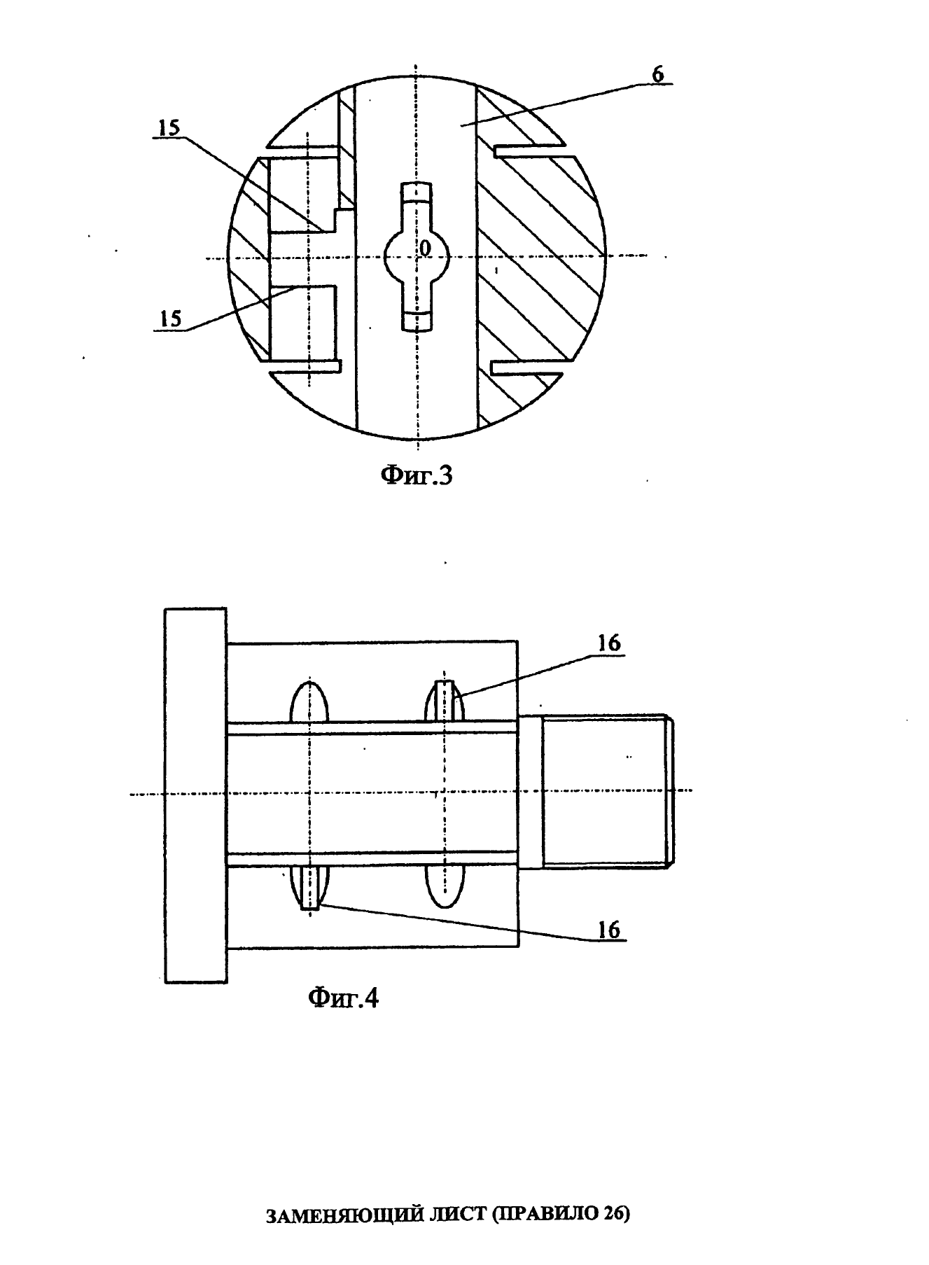

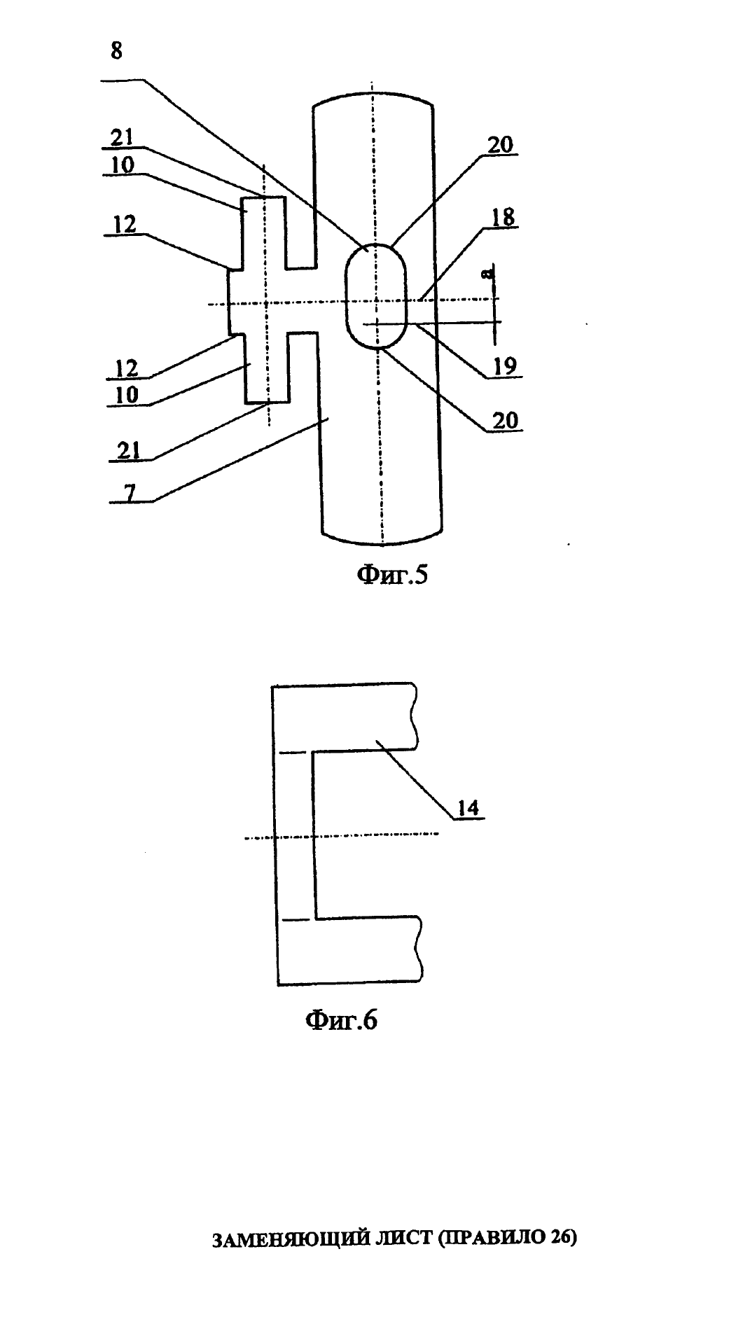

The cylinder also has additional spring-mounted bearing lands 11; these lands are symmetrical relative to the center of the cylinder and represent the bottom of cup-shaped apertures (FIG. 3). The cylinder has recesses to alloy the passage of the plates 7, which are also embodied as lands (FIG. 4); the distance between these lands is not less than the distances between the bearing lands 12 of plates 7.

The axis 17 of the channel 4 for the key and the transverse axes 18 of the apertures 8 of plates 7 pass through the center 0 of the cylinder 3. This latter condition ensures the symmetrical positioning of the lands 15 relative to the center 0 of the cylinder 3 and the symmetrical disposition of the lands 12 relative to the axes 18 of the apertures 8.

The center lines 19 of the longitudinal dimensions of plates 7 (the dimensions oriented along the direction of movement of plates 7) are parallel to the transverse axes 18 of the plate apertures 8 of the plates and displaced relative to them by a magnitude “a” corresponding to the locking ends of plates 9 and 7. The contact edges 20 of the plate apertures 8 are symmetrical relative the transverse axes 18 of these apertures.

The lock has elements to ensure the equality of the maximum travel of the plates 7 in both directions; for each code position they include guide rods 10, the ends of which 21 are symmetrical relative to the axis 18 of apertures 8, that is, the center 0 of cylinder 3, and are likewise symmetrical relative to this center.

The cylinder 3 is connected with a specially locking device of the lock 22 (shown in part).

The lock operates as follows.

The locking plates 7 accept the required code. To do this, plates 7 together with springs 11 are set on the bearing lands 15 of cylinder 3 and plates 7 move into recesses 6 and 16 of the cylinder 3. As this occurs, the locking ends 9 of the plates enter the channel of the body 1, which provides locking (blocking) of rotatable cylinder 3. This is achieved without the movement (displacement) of the actual plates 7, but only the cited displacement of their longitudinal dimensions relative to apertures 8.

At the same time, the cited symmetrical disposition of the lands 15 prevents an initial displacement of the plates 7 in the direction of lock opening (movement of plates from the channel 2 of body 1), which could occur as the result of differing stiffnesses of the springs 11. That is, the cylinder is normally closed. As this occurs, the transverse axes 18 of the apertures 8 of plates 7 pass through the center 0 of cylinder 3. This allows the code to be received by plates 7, which have the cited displacement of the longitudinal dimension relative to their apertures, by which they are set in both the upper and the lower code position without displacement of the contact edges 20 of the windows 8 of one set of plates relative to the corresponding edges of the other stepped plates.

The achievement of this result is also helped by the symmetrical disposition of the contact edges 20 of the apertures relative to the transverse axes of the apertures.

The lock is opened by introducing the key 5 through channel 4 into the packet of locking plates 7. The cited orientation of the channel 4 and the apertures 8 along the center of the cylinder 3 allows the key 5 to be oriented relative to the apertures 8 of the plates, as a result of which, as key passes through the apertures 8 the plates are displaced by it, and their locking ends 9 enter the channel 2 of body 1. At the same time, the bearing lands of the plates remove the springs 11 from the bearing lands 15 of cylinder 3.

The cylinder is unblocked and as it continues to turn, the lock opens. It is prudent to use resettable code keys for the given lock, such as those covered, for instance, by Russian patent No. 2097519. When this is done, the spring-supported plates do not allow a stranger to obtain information about the direction of the operating direction of the plates. This also strengthens the interaction of the ends of the rods of the plates with the bearing lands of the cylinder at maximum travel of the plates away compression, since it ensures the equality of these motions in both directions.

The absence of steps in the contact edges of the plate apertures in the closed cylinder prevents a stranger from obtaining information about position of each locking plate in the cylinder, thereby enhancing the secrecy of the lock and its reliability. The use of replaceable code plates simplifies resetting the lock to a different code. When this is done, the use of each plate in each of the code positions expand the code possibilities of the lock. Resetting and installation of the lock are also aided by the absence of resistance from the plates to the body of the lock (in the given design: resistance to the bearing lands of the cylinder) and the use of removable support brackets as such bearing lands. The lock may find application as a locking device for premises and means of transportation of various kinds, various types of apparatus, safes, and for switches for various means of transportation.

1. A Baradchenko cylindrical lock that comprises a body with slots, a rotatable cylinder disposed in the body provided with a key slot and recesses which are diametrically embodied in the cross-sections thereof, a packet of locking plates, movably arranged in the slots of the cylinder in such a way that the locking ends are insertable into the body slot, which ends are spring-loaded between their bearing plates and the bearing lands of the cylinder in one direction of their motion, and having an aperture for a key, characterized in that the contact edges of the plate apertures are symmetrical relative the transverse axes of these apertures, and the longitudinal dimensions of the locking plates are displaced relative to the transverse axes of these apertures by the magnitude of their locking ends, with the plates likewise being spring-loaded in the other direction of their motion and provided with equalizing elements to their maximum movement in both directions.

2. A Baradchenko cylindrical lock as claimed in claim characterized in the elements provided to ensure the equality of maximum travel in both directions of the plates include plate guide rods for the springs and bearing lands of the cylinder, wherein the pairs of ends of corresponding rods and pairs of bearing lands are symmetrical relative to the center of the cylinder.

3. A Baradchenko cylindrical lock as claimed in claim characterized in that the bearing lands of the cylinder are made removable, in the form of support brackets.

4. A Baradchenko cylindrical lock as claimed in claim 1 characterized in that each code position has additional spring-loaded bearing lands of the cylinder that are symmetrical relative to the center of the cylinder and have recesses to allow the movement of the plates, with the distance between these bearing lands being not less than the distances between the bearing lands of the plates.
